(19) United States
(12) Patent Application Publication
(10) Pub. No.: US 2026/0334560 A1
(43) Pub. Date: Oct. 29, 2026

(54) AEROSOL-GENERATING DEVICE WITH A HEATING ASSEMBLY AND AN EXTRACTOR

(71) Applicant: Philip Morris Products S.A., Neuchatel (CH)

(72) Inventors: Rui Nuno Rodrigues Alves BATISTA, Morges (CH); Cristina FERRAZ RIGO, Pully (CH); Valerio OLIANA, Pully (CH)

(73) Assignee: Philip Morris Products S.A., Neuchatel (CH)

(21) Appl. No.: 19/129,067

(22) PCT Filed: Dec. 15, 2023
(86) PCT No.: PCT/EP2023/086127

§ 371 Date: May 12, 2025

(30) Foreign Application Priority Data
Dec. 15, 2022 (EP) 22213960.2

(51) Int. Cl. A24F 40/465; A24F 40/20; H05B 6/10

(52) U.S. Cl. CPC A24F 40/465; A24F 40/20; H05B 6/105

(57) ABSTRACT

An aerosol-generating device is provided, including: a heating cavity configured to receive an aerosol-forming substrate; a heating assembly arranged in the heating cavity, the heating assembly including a planar inductor coil; and an extractor including an extractor surface movable within the heating cavity, a distal end surface of the heating cavity being defined by the extractor surface, at least a portion of the extractor surface being formed by a portion of the heating assembly, and a portion of a surface of the inductor coil forming at least a portion of the extractor surface.

The present disclosure relates to an aerosol-generating device and an aerosol-generating system comprising an aerosol-generating device.

Some known aerosol-generating systems comprise an aerosol-generating device having a power supply, such as a battery, a controller, and a heating element for heating an aerosol-forming substrate. In some examples, the aerosol-forming substrate comprises a tobacco rod or a tobacco plug that is arranged in an aerosol-generating article. In use, the aerosol-generating article is inserted into a heating cavity of the aerosol-generating device, and the heating element either penetrates the aerosol-forming substrate or is arranged around the outside of the aerosol-forming substrate. Power is supplied to the heating element from the power supply to heat the aerosol-forming substrate, and volatile components of the aerosol-forming substrate are vaporised and released and condense to form an aerosol, which is inhalable by a user. In some such aerosol-generating systems, the aerosol-generating article resembles a conventional cigarette, having a similar cylindrical stick like configuration.

It would be desirable to provide an aerosol-generating system that is able to facilitate removal of the aerosol-forming substrate from the aerosol-generating device. It would be desirable to provide an aerosol-generating system that is able to heat more than one aerosol-forming substrate to improve the control a user has over the aerosol generated by the aerosol-generating system. It would also be desirable to provide an aerosol-generating system that is even more compact, and easier to manufacture.

According to the present disclosure there is provided an aerosol-generating device. The aerosol-generating device may comprise a heating cavity configured to receive an aerosol-forming substrate. The aerosol-generating device may comprise a heating assembly arranged in the heating cavity. The aerosol-generating device may comprise an extractor. The extractor may comprise an extractor surface movable within the heating cavity. At least a portion of the extractor surface may be formed by a portion of the heating assembly.

According to the present disclosure there is provided an aerosol-generating device comprising: a heating cavity configured to receive an aerosol-forming substrate; a heating assembly arranged in the heating cavity; and an extractor comprising an extractor surface movable within the heating cavity, wherein at least a portion of the extractor surface is formed by a portion of the heating assembly.

Advantageously, providing the aerosol-generating device with an extractor may facilitate removal of the aerosol-forming substrate from the heating cavity. Advantageously, forming at least a portion of an extractor surface that is movable in the heating cavity from a portion of a heating assembly may reduce the number of component parts required in the aerosol-generating device. Advantageously, forming at least a portion of an extractor surface that is movable in the heating cavity from a portion of a heating assembly may facilitate manufacture of the aerosol-generating device.

In some preferred embodiments, the heating assembly comprises a heating element. In some of these embodiments, a portion of the heating element may form a portion of the extractor surface. In some embodiments, the heating element may form a portion of the extractor surface.

Advantageously, forming a portion of the extractor surface from at least a portion of a heating element may facilitate heat transfer from the heating element to an aerosol-forming substrate received in the heating cavity.

When an aerosol-forming substrate is received in the heating cavity, the aerosol-forming substrate may contact the extractor surface. Where at least a portion of the extractor surface is formed from a heating element, an aerosol-forming substrate received in the heating cavity may contact the heating element.

As used herein, “aerosol-generating device” refers to a device that interacts with an aero-sol-forming substrate to generate an aerosol.

As used herein, “aerosol-forming substrate” refers to a substrate capable of releasing volatile compounds that can form an aerosol. Such volatile compounds may be released by heating the aerosol-forming substrate. An aerosol-forming substrate is typically part of an aerosol-generating article.

As used herein, “aerosol-generating article” refers to an article comprising an aerosol-forming substrate that is capable of releasing volatile compounds that can form an aero-sol. For example, an aerosol-generating article may be an article that generates an aero-sol that is directly inhalable by the user drawing or puffing on a mouthpiece at a proximal or mouth end of the aerosol-generating article, an aerosol-generating device, or an aero-sol-generating system. An aerosol-generating article may be disposable.

As used herein, “aerosol-generating system” refers to the combination of an aerosol-generating device with an aerosol-generating article. In an aerosol-generating system, the aerosol-generating article and the aerosol-generating device cooperate to generate an aerosol.

As used herein, “proximal” refers to a user end, or mouth end of the aerosol-generating device, aerosol-generating article, or aerosol-generating system. The proximal end of a component of an aerosol-generating device, an aerosol-generating article, or an aerosol-generating system is the end of the component closest to the user end, or mouth end of the aerosol-generating device, the aerosol-generating article, or the aerosol-generating system. As used herein, “distal” refers to the end opposite the proximal end.

As used herein, “end” and “side” are used interchangeably to refer to extremities of a feature, such as an aerosol-generating device, a heating assembly, a heating element, or an aerosol-generating article. Preferably, features described herein have two opposing ends and at least one side extending between the two opposing ends. Preferably, features described herein have a length extending in a longitudinal direction between opposing ends, and a width extending in a transverse direction between two opposing sides.

As used herein, “length” refers to the maximum dimension of a feature in a longitudinal direction of the feature.

As used herein, “width” refers to the maximum dimension of a feature in a transverse direction of the feature. The transverse direction is perpendicular to the longitudinal direction.

As used herein, “thickness” and “depth” refer to the maximum dimension of a feature in a direction perpendicular to the longitudinal direction of the feature and perpendicular to the transverse direction of the feature.

The heating cavity has a longitudinal axis. In some embodiments the extractor surface is movable along the longitudinal axis of the heating cavity.

The extractor surface may be movable in the heating cavity in any suitable way. Preferably, the extractor surface is slidable within the heating cavity. Preferably, the extractor surface is translatable within the heating cavity.

The heating cavity may have a proximal end. The heating cavity may have a distal end, opposite the proximal end. The proximal end may be substantially open. The proximal end may be substantially open to enable the aerosol-forming substrate to be inserted into the heating cavity and removed from the heating cavity.

The extractor surface may be movable from a first position to a second position. The extractor surface may be movable in a proximal direction, towards the proximal end of the heating cavity, from the first position to the second position.

The extractor surface may be movable from a second position to a first position. The extractor surface may be movable in a distal direction, towards the distal end of the heating cavity, from the second position to the first position.

The first position may be a heating position, in which an aerosol-forming substrate is able to be received in the heating cavity and heated by the heating assembly. The second position may be an extraction position, in which an aerosol-forming substrate received in the heating cavity is located at, around or outside the open proximal end of the heating cavity. In the second position the extractor surface may be arranged at the open proximal end of the heating cavity. In the second position, the extractor surface may be arranged outside of the heating cavity.

The extractor surface may be movable from the first position to a third position. The extractor surface may be movable in a distal direction, towards the distal end of the heating cavity, from the first position to the third position.

The extractor surface may be movable from a third position to the first position. The extractor surface may be movable in a proximal direction, towards the proximal end of the heating cavity, from the third position to the first position.

The third position may be an additional heating position, in which a greater volume of aerosol-forming substrate is able to be received in the heating cavity and heated by the heating assembly compared to when the extractor surface is in the first position.

Advantageously, providing the aerosol-generating device with two heating positions that enable the aerosol-generating device to receive and heat two different volumes of aerosol-forming substrate may enable a user to customise the aerosol generated by the aerosol-generating system. For example, a user may be able to customise the amount of aerosol generated by the aerosol-generating system by varying the amount of aerosol-forming substrate received in the heating cavity. For example, a user may be able to customise the composition of aerosol generated by the aerosol-generating system by inserting two or more different aerosol-forming substrates into the heating cavity.

The extractor surface may take any suitable form.

The extractor surface may be planar, extending substantially in a plane.

As used herein, “planar” refers to a feature generally formed in a single Euclidean plane and not wrapped around or otherwise conformed to fit a curved or other non-planar shape. A planar surface extends in two dimensions in a single Euclidean plane. A planar object extends in two dimensions in a single Euclidean plane substantially more than in a third dimension parallel to the plane. More specifically, a planar object extends in a first dimension and a second dimension perpendicular to the first dimension at least two, five or ten times further than the object extends in a third dimension perpendicular to the first and second dimensions. Advantageously, planar components of a heating assembly may be easily handled during manufacture and provide for a robust construction.

The extractor surface may have any suitable shape. For example, the extractor surface may be substantially circular, oval, hexagonal, polygonal, rectangular, square, or any other suitable polygonal shape. Preferably, the extractor surface is substantially circular.

In some preferred embodiments, a surface of the heating cavity is defined by the extractor surface. In these embodiments, the extractor surface may define a distal end surface of the heating cavity. In some of these embodiments where the extractor surface is substantially circular the heating cavity is substantially cylindrical.

The heating cavity is configured to receive an aerosol-forming substrate. Where the aerosol-forming substrate is comprised in an aerosol-generating article, the heating cavity may be configured to receive at least a portion of an aerosol-generating article.

The heating cavity may be configured to receive a first aerosol-forming substrate and a second aerosol-forming substrate. Where the first aerosol-forming substrate and the second aerosol-forming substrate are comprised in an aerosol-generating article, the heating cavity may be configured to receive the aerosol-generating article.

The heating cavity may have any suitable form.

The heating cavity has a transverse cross-sectional shape. The transverse cross-sectional shape of the heating cavity may have any suitable shape. The transverse cross-sectional shape of the heating cavity may be one of circular, elliptical, polygonal, square, or rectangular. Preferably, the transverse cross-sectional shape of the heating cavity is circular.

As used herein, a “transverse cross-section” is a cross-section of a feature taken perpendicular to the longitudinal direction of the feature.

The heating cavity has a heating cavity length. The heating cavity length may be any suitable length. The heating cavity length may be between about 45 millimetres and about 55 millimetres.

The heating cavity has a heating cavity width. The heating cavity width may be any suitable width. The heating cavity width may be between about 10 millimetres and about 15 millimetres.

The heating cavity has a heating cavity depth. The heating cavity depth may be any suitable depth. The heating cavity depth may be between about 0.10 millimetres and about 7 millimetres.

The heating cavity has a proximal end and a distal end. Preferably, the proximal end of the heating cavity is open for receiving the aerosol-forming substrate. Preferably, distal end of the heating cavity is substantially closed.

The aerosol-generating device comprises a heating assembly. At least a portion of the heating assembly forms at least a portion of the extractor surface.

The heating assembly may comprise a heating element. In some embodiments, a surface of the heating element forms at least a portion of the extractor surface. In some embodiments, a portion of the extractor surface is formed by a portion of a surface of the heating element. In some embodiments, the entire extractor surface is formed by a surface of the heating element.

The heating element may be a planar heating element. The heating element may be a flat heating element. The heating element may be a flat, planar heating element.

As used herein, “flat” refers to a substantially two dimensional topological manifold. In other words, “flat” means substantially two-dimensional. An example of a flat object is a structure between two substantially parallel surfaces, wherein the distance between the two surfaces is substantially smaller than the extension within the surfaces. A flat feature extends in two dimensions substantially more than in a third dimension. More specifically, a flat feature extends in a first dimension and a second dimension perpendicular to the first dimension at least five times further than the feature extends in a third dimension perpendicular to the first and second dimensions. A substantially flat feature may be planar. A substantially flat feature may be curved along one or more dimensions, for example forming a dome shape or bridge shape. Advantageously, flat components of a heating assembly may be easily handled during manufacture and provide for a robust construction.

The heating element may have any suitable shape. The heating element shape may be one of circular, elliptical, polygonal, square, rectangular, or any other regular polygon. Preferably, the heating element shape is circular.

In some preferred embodiments, the heating element is a flat, planar disc.

As used herein, “disc” refers to a right circular cylinder having a diameter that is at least five times as greater as a depth.

The heating element may have any suitable size.

The heating element has a heating element length. The heating element length may be any suitable length. The heating element length may be between about 12 millimetres and about 22 millimetres.

The heating element has a heating element width. The heating element width may be any suitable width. The heating element width may be between about 12 millimetres and about 22 millimetres.

The heating element has a heating element thickness. The heating element thickness may be any suitable thickness. The heating element thickness may be between about 0.1 millimetres and about 0.5 millimetres.

The heating element may be made from any suitable material.

The heating element may be formed from an electrically conductive material.

As used herein, “electrically conductive” refers to a material having a volume resistivity at 20 degrees Celsius (°C) of less than about 1×10⁻⁵ ohm-metres (Ωm), typically between about 1×10⁻⁵ ohm-metres (Ωm) and about 1×10⁻⁹ ohm-metres (Ωm)

The heating element may be formed from a thermally conductive material.

As used herein, “thermally conductive” refers to a material having a bulk thermal conductivity of at least about 10 Watts per metre Kelvin (mW/(m K)) at 23 degrees Celsius (°C) and a relative humidity of 50 percent as measured using the modified transient plane source (MTPS) method.

The heating element may be formed from at least one of: graphite, molybdenum, silicon carbide, a metal, stainless steel, niobium, aluminium, nickel, titanium, and composites of metallic materials.

The heating assembly may be any suitable type of heating assembly. The heating element may be any suitable type of heating element.

The heating assembly may be a resistive heating assembly. In some embodiments, the heating element is a resistive heating element.

In some embodiments, the heating assembly is an inductive heating assembly.

The heating assembly may comprise an inductor coil.

The inductor coil may have any suitable form. The inductor coil may be a tubular inductor coil. The inductor coil may be a planar inductor coil. The inductor coil may be a flat inductor coil. Preferably, the inductor coil may be a flat, planar inductor coil.

The inductor coil has an inductor coil shape. The inductor coil shape may be any suitable shape. The inductor coil may have one of a circular shape, an elliptical shape, a polygonal shape, a square shape, or preferably a rectangular shape. Preferably, the inductor coil has the same shape as the heating element.

As used herein a “planar inductor coil” refers to a coil that generally lies on a single Euclidean plane, wherein the axis of winding of the coil is normal to the plane on which the coil lies. A planar inductor coil can have any desired shape within the plane of the coil. For example, a planar indication coil may have a circular shape or an oblong or rectangular shape. Preferably, the inductor coil is a spiral coil. Particularly preferably, the inductor coil is a planar, circular, spiral coil.

The inductor coil has an inductor coil size. The inductor coil size may be any suitable size. The inductor coil has an inductor coil length. The inductor coil length may be any suitable length. The inductor coil length may be between about 15 millimetres and about 20 millimetres. The inductor coil has an inductor coil width. The inductor coil width may be any suitable width. The inductor coil width may be between about 10 millimetres and about 15 millimetres. The inductor coil has an inductor coil thickness. The inductor coil thickness may be any suitable thickness. The inductor coil thickness may be between about 0.1 millimetres and about 0.5 millimetres.

The inductor coil may have any suitable number of turns.

The inductor coil may be formed from any suitable material. The inductor coil may be formed from at least one of: silver, gold, aluminium, brass, zinc, iron, nickel, and alloys of thereof, and electrically conductive ceramics, such as yttrium-doped zirconia, indium tin oxide, and yttrium doped titanate.

The inductor coil shape may be different to the heating element shape. In some preferred embodiments, the inductor coil shape is substantially the same as the heating element shape.

Where the heating assembly comprises a heating element, the inductor coil size may be different to the heating element size. In some preferred embodiments, the inductor coil size is substantially the same as the heating element size.

Preferably, the heating element may be arranged between the extractor surface and the inductor coil. The inductor coil may be arranged distal to the heating element. The inductor coil may be arranged beneath the heating element.

The inductor coil may generate a varying magnetic field when a varying current is supplied to the inductor coil.

As used herein, “varying current” refers to a current that varies with time. An inductor coil generates a varying magnetic field when a varying electric current is supplied to the inductor coil. The term “varying current” is intended to include alternating currents. Where the varying current is an alternating current, the alternating current generates an alternating magnetic field.

The varying current may be an alternating current. As used herein, “alternating current” refers to a current that periodically reverses direction. The alternating current may have any suitable frequency. Suitable frequencies for the alternating current may be between 100 kilohertz (kHz) and 30 megahertz (MHz). Where the at least one inductor coil is a tubular inductor coil, the alternating current may have a frequency of between 500 kilohertz (kHz) and 30 megahertz (MHz). Where the at least one inductor coil is a flat coil, the alternating current may have a frequency of be-tween 100 kilohertz (kHz), and 1 megahertz (MHz).

The heating element may be a susceptor element. The heating element may be a planar susceptor element.

As used herein, a “susceptor element” refers to an element that is heatable by penetration with a varying magnetic field. A susceptor element is typically heatable by at least one of Joule heating through induction of eddy currents in the susceptor element, and hysteresis losses.

Where the heating assembly comprises an inductor coil, and the heating element is a susceptor element, the susceptor element may be arranged to be penetrated by the varying magnetic field generated by the inductor coil when the varying current is supplied to the inductor coil.

The susceptor element may be formed from any suitable material. Preferably, the susceptor element comprises a magnetic material that is heatable by penetration with a varying magnetic field. The magnetic material may be a ferromagnetic material, such as ferrite, ferritic iron, a ferromagnetic alloy, a ferromagnetic steel, or a ferromagnetic stainless steel such as SAE 400 series stainless steels, SAE type 409, 410, 420 or 430 stainless steels.

As used herein, “magnetic material” refers to a material which is able to interact with a magnetic field, including both paramagnetic and ferromagnetic materials.

In some preferred embodiments, the susceptor element comprises at least about 5 percent, or at least about 20 percent, or at least about 50 percent, or at least about 90 percent of ferromagnetic or paramagnetic materials on a dry weight basis.

The susceptor element shape may be different to the inductor coil shape. Preferably, the susceptor element shape is substantially the same as the inductor coil shape.

The inductor coil size may be different to the inductor coil size. Preferably, the susceptor element size is substantially the same as the inductor coil size.

In some embodiments, the extractor comprises the inductor coil. In some embodiments, a surface of the inductor coil forms at least a portion of the extractor surface. In some embodiments, a portion of the extractor surface is formed by a portion of a surface of the inductor coil. In some embodiments, the extractor surface is formed by a surface of the inductor coil.

Where at least a portion of the extractor surface is formed by a portion of a surface of the inductor coil, the heating assembly typically does not comprise a heating element. In these embodiments, the heating element is typically comprised in an aerosol-generating article. The aerosol-generating article may comprise an aerosol-forming substrate and a heating element, in the form of a susceptor element. Where the heating assembly comprises an inductor coil, and the heating element is a susceptor element comprised in an aerosol-generating article, the susceptor element may be arranged to be penetrated by the varying magnetic field generated by the inductor coil when the varying current is supplied to the inductor coil and the aerosol-generating article is received in the heating cavity.

Where the heating assembly comprises an inductor coil, the inductor coil may be movable with the extractor surface of the extractor.

Making the inductor coil movable with the extractor surface may enable the inductor coil to be maintained at a constant distance from the susceptor element. Advantageously, maintaining the inductor coil at a constant distance from the susceptor element may enable the position of the inductor coil to the susceptor element to be maintained in the optimal position for inductive heating of the susceptor element by the varying magnetic field generated by the inductor coil.

The heating assembly may further comprise a shielding element.

The shielding element may be a planar shielding element extending in a plane. The shielding element may be a flat shielding element. The shielding element may be a flat, planar shielding element.

The shielding element may be arranged in any suitable location. Where the heating assembly comprises a heating element, the heating element may be arranged between the extractor surface and the shielding element. Where the heating assembly comprises an inductor coil, the inductor coil may be arranged between the extractor surface and the shielding element. Where the heating assembly comprises a heating element and an inductor coil, the inductor coil may be arranged between the heating element and the shielding element.

The shielding element has a shielding element shape. The shielding element shape may be any suitable shape. Where the heating assembly comprises a heating element, the shielding element shape may be different to the heating element shape. Preferably, the shielding element shape is substantially the same as the heating element shape. Where the heating assembly comprises an inductor coil, the shielding element shape may be different to the inductor coil shape. Preferably, the shielding element shape is substantially the same as the inductor coil shape. The shielding element may have a shape that is circular, oval, square, rectangular or any other regular polygon.

In some preferred embodiments, the shielding element is a flat, planar disc.

The shielding element has a shielding element size. The shielding element size may be any suitable size. Where the heating assembly comprises a heating element, the shielding element size may be different to the heating element size. Where the heating assembly comprises a heating element, preferably the shielding element size is substantially the same as the heating element size. Where the heating assembly comprises an inductor coil, the shielding element size may be different to the inductor coil size. Where the heating assembly comprises an inductor coil, preferably the shielding element size is substantially the same as the inductor coil size.

The shielding element has a shielding element length. The shielding element length may be any suitable length. The shielding element length may be between about 15 millimetres and about 20 millimetres. The shielding element has a shielding element width. The shielding element width may be any suitable width. The shielding element width may be between about 10 millimetres and about 15 millimetres. The shielding element has a shielding element thickness. The shielding element thickness may be any suitable thickness. The shielding element thickness may be between about 0.1 millimetres and about 0.5 millimetres.

The shielding element may be formed from any suitable material.

The shielding element may be formed from an electrically conductive material. The shielding element may comprise a metal or a metal alloy. The shielding element may comprise one or more of: copper, nickel, silver, a silver-aluminium alloy, a silver-copper alloy, silver-glass fibre, and a nickel-graphite alloy. The shielding element may comprise a copper alloy. The shielding element may comprise Nickel Silver. In other words, the shielding element may comprise an alloy of copper, nickel and zinc. The shielding element may comprise copper alloy 770. The shielding element may comprise an alloy comprising 55 percent by weight of copper, 27 percent by weight of zinc, and 18 percent by weight of nickel.

The shielding element may comprise silicon. The shielding element may comprise a silicon substrate including metal particles. The metal particles may comprise one or more of: copper, nickel, silver, a silver-aluminium alloy, a silver-copper alloy, silver-glass fibre, and a nickel-graphite alloy.

The shielding element may be formed from a material having a relative magnetic permeability of at least 5, or at least 10, or at least 20, or at least 30, or at least 40, or at least 50, or at least 60, or at least 80, or at least 100 for a frequency of between 6 and 8 megahertz (MHz) and a temperature of 25 degrees Celsius. Advantageously, providing a shielding element with such a relative magnetic permeability may enable the shielding element to shield one or more of the outside of the device and other components of the device from any varying magnetic fields generated by the heating assembly.

The shielding element may comprise a magnetic material. The shielding element may comprise at least about 5 percent, or at least about 20 percent, or at least about 50 percent, or at least about 90 percent of ferromagnetic or paramagnetic materials on a dry weight basis. The magnetic material of the shielding element may be a ferromagnetic material, such as ferrite, ferritic iron, a ferromagnetic alloy, a ferromagnetic steel, or a ferromagnetic stainless steel such as SAE 400 series stainless steels, SAE type 409, 410, 420 or 430 stainless steels.

Advantageously, forming the shielding element from a magnetic material may enable the shielding element to shield one or more of the outside of the device and other components of the device from any varying magnetic fields generated by the heating assembly.

In some embodiments, the entire heating assembly is movable within the heating cavity with the extractor surface. In some embodiments, a portion of the heating assembly is movable within the heating cavity with the extractor surface. Where the heating assembly comprises a heating element, the heating element may be movable within the heating cavity with the extractor surface. Where the heating assembly comprises an inductor coil, the inductor coil may be movable within the heating cavity with the extractor surface. Where the heating assembly comprises a shielding element, the shielding element may be movable within the heating cavity with the extractor surface.

The aerosol-generating device may comprise more than one heating assembly. The aerosol-generating device may comprise a first heating assembly and a second heating assembly.

The aerosol-generating device may comprise a first heating assembly comprising a first heating element and a second heating assembly comprising a second heating element. The first heating assembly may comprise a first planar heating element extending in a plane. The second heating assembly may comprise a second planar heating element extending in the plane of the first heating element. The second planar heating element may circumscribe the first heating element.

It is envisaged that, according to the present disclosure, an aerosol-generating device comprising a first heating assembly and a second heating assembly may or may not comprise an extractor.

Where the first heating assembly comprises a first heating element and the second heating assembly comprises a second heating element, the first heating element may be formed from the same material as the second heating element. In some embodiments, the first heating element is formed from a different material to the second heating element.

According to the present disclosure, there is provided an aerosol-generating device. The aerosol-generating device may comprise a first heating assembly. The first heating assembly may comprise a first planar heating element extending in a plane. The aerosol-generating device may comprise a second heating assembly. The second heating assembly may comprise a second planar heating element extending in the plane of the first heating element. The second planar heating element may circumscribe the first heating element.

According to the present disclosure, there is provided an aerosol-generating device comprising: a first heating assembly comprising a first planar heating element extending in a plane; and a second heating assembly comprising a second planar heating element extending in the plane of the first heating element, and circumscribing the first heating element.

In some preferred embodiments, the first heating element is substantially circular, and the second heating element forms a ring circumscribing the first heating element.

In some particularly preferred embodiments, the first heating element is a flat, planar disc, and the second heating element is a flat, planar ring, circumscribing the first aerosol-forming substrate.

The first heating assembly may be any suitable type of heating assembly. The second heating assembly may be any suitable type of heating assembly. The first heating assembly and the second heating assembly may be the same type of heating assembly. The second heating assembly may be a different type of heating assembly to the first heating assembly.

The first heating assembly may be a resistive heating assembly. The first heating assembly may comprise a first heating element that is a resistive heating element.

The second heating assembly may be a resistive heating assembly. The second heating assembly may comprise a second heating element that is a resistive heating element.

The first heating assembly may be an inductive heating assembly. The first heating assembly may comprise a first heating element that is a susceptor element.

The second heating assembly may be an inductive heating assembly. The second heating assembly may comprise a second heating element that is a susceptor element.

Where the first heating assembly is an inductive heating assembly, the first heating assembly may comprise a first inductor coil. The first inductor coil may generate a first varying magnetic field when a first varying current is supplied to the first inductor coil.

Where the first heating assembly is an inductive heating assembly, the first heating assembly may or may not comprise a first heating element. Where the first heating assembly comprises a first heating element, the first heating element may be arranged to be penetrated by the first varying magnetic field generated by the first inductor coil. At least a portion of a surface of the first heating element may form at least a portion of the extractor surface. Where the first heating assembly does not comprise a first heating element, at least a portion of a surface of the first inductor coil may form at least a portion of the extractor surface.

Where the second heating assembly is an inductive heating assembly, the second heating assembly may comprise a second inductor coil. The second inductor coil may generate a second varying magnetic field when a second varying current is supplied to the second inductor coil.

The second heating assembly may or may not comprise a second heating element. Where the second heating assembly comprises a second heating element, the second heating element may be arranged to be penetrated by the second varying magnetic field generated by the second inductor coil. At least a portion of a surface of the second heating element may form at least a portion of the extractor surface. Where the second heating assembly does not comprise a second heating element, at least a portion of a surface of the second inductor coil may form at least a portion of the extractor surface.

The aerosol-generating device may comprise a first heating assembly comprising a first heating element and a second heating assembly comprising a second heating element, wherein at least a portion of a surface of the first heating element forms a portion of the extractor surface and at least a portion of a surface of the second heating element forms a portion of the extractor surface.

The aerosol-generating device may comprise a first heating assembly comprising a first inductor coil and a second heating assembly comprising a second inductor coil, wherein at least a portion of a surface of the first inductor coil forms a portion of the extractor surface and at least a portion of a surface of the second inductor coil forms a portion of the extractor surface.

The aerosol-generating device may comprise a first heating assembly comprising a first heating element and a second heating assembly comprising a second inductor coil, wherein at least a portion of a surface of the first heating element forms a portion of the extractor surface and at least a portion of a surface of the second inductor coil forms a portion of the extractor surface.

The aerosol-generating device may comprise a first heating assembly comprising a first inductor coil and a second heating assembly comprising a second heating element, wherein at least a portion of a surface of the first inductor coil forms a portion of the extractor surface and at least a portion of a surface of the second heating element forms a portion of the extractor surface.

In some embodiments where the first heating assembly is an inductive heating assembly and the second heating assembly is an inductive heating assembly, the first heating assembly may comprise an inductor coil, and the second heating assembly may comprise the same inductor coil. The inductor coil may generate a varying magnetic field when a varying current is supplied to the inductor coil. The first heating element may be arranged to be penetrated by the varying magnetic field generated by the inductor coil and the second heating element may be arranged to be penetrated by the varying magnetic field generated by the inductor coil.

The aerosol-generating device may comprise a controller. The controller may comprise a microprocessor, which may be a programmable microprocessor, a microcontroller, or an application specific integrated chip (ASIC) or other electronic circuitry capable of providing control. The controller may comprise further electronic components.

The controller may be configured to control a supply of power to the heating assembly. Where the heating assembly comprises a heating element, the controller may be configured to control a supply of power to the heating element to heat the heating element. Where the heating assembly comprises an inductor coil, the controller may be configured to control a supply of power to the inductor coil. Where the heating assembly comprises an inductor coil, the controller may be configured to supply a varying current to the inductor coil to generate a varying magnetic field. The controller may be configured to supply an alternating current to the inductor coil to generate an alternating magnetic field.

Where the aerosol-generating device comprises a first heating assembly and a second heating assembly, the controller may be configured to control a supply of power to the first heating assembly and to control a supply of power to the second heating assembly. Where the first heating assembly comprises a first heating element and the second heating assembly comprises a second heating element, the controller may be configured to control a supply of power to the first heating element and to control a supply of power to the second heating element. Where the first heating assembly comprises a first inductor coil and the second heating assembly comprises a second inductor coil, the controller may be configured to control a supply of power to the first inductor coil and to control a supply of power to the second inductor coil.

The controller may be configured to selectively control the supply of power to the first heating assembly and selectively control the supply of power to the second heating assembly. The aerosol-generating device may comprise a user interface. The user interface may have a first user input configured to enable a user to selectively control the supply of power to the first heating assembly. The user interface may have a second user input configured to enable a user to selectively control the supply of power to the second heating assembly.

The user interface may be any suitable user interface. The user interface may comprise one or more physical user inputs, such as buttons or switches. The user interface may comprise a touch screen. Where the user interface comprises a touch screen, the one or more user inputs may be portions of the touch screen.

Advantageously, enabling selective control of the supply of power to the first heating assembly and selective control of the supply of power to the second heating assembly may provide a user with improved control over the aerosol generated by the aerosol-generating device from an aerosol-forming substrate received in the heating cavity.

Where the first heating assembly comprises a first heating element, the controller may be configured to control the supply of power to the first heating assembly to heat the first a first operating temperature.

Where the second heating assembly comprises a second heating element, the controller may be configured to control the supply of power to the second heating assembly to heat the second heating element to a second operating temperature. In some embodiments, the second operating temperature is the same as the first operating temperature. In some preferred embodiments, the second operating temperature is different to the first operating temperature.

As used herein, an “operating temperature” is a temperature at which volatile compounds are released from an aerosol-forming substrate.

The controller may be configured to control the supply of power to the first heating assembly to heat the first heating element to a first operating temperature of at least about 100 degrees Celsius, or at least about 200 degrees Celsius, or at least about 300 degrees Celsius. The controller may be configured to control the supply of power to the first heating assembly to heat the first heating element to a first operating temperature of no more than about 350 degrees Celsius, or no more than about 280 degrees Celsius. The controller may be configured to control the supply of power to the first heating assembly to heat the first heating element to a first operating temperature of between about 100 degrees Celsius and about 350 degrees Celsius, or between about 200 degrees Celsius and about 280 degrees Celsius.

The controller may be configured to control the supply of power to the second heating assembly to heat the second heating element to a second operating temperature of at least about 100 degrees Celsius, or at least about 200 degrees Celsius, or at least about 300 degrees Celsius. The controller may be configured to control the supply of power to the second heating assembly to heat the second heating element to a second operating temperature of no more than about 350 degrees Celsius, or no more than about 280 degrees Celsius. The controller may be configured to control the supply of power to the second heating assembly to heat the second heating element to a second operating temperature of between about 100 degrees Celsius and about 350 degrees Celsius, or between about 200 degrees Celsius and about 280 degrees Celsius.

The controller may be configured to control the supply of power to the second heating assembly independent of the supply of power to the first heating assembly.

Advantageously, controlling the supply of power to the second heating assembly independent of the supply of power to the first heating assembly may enable improved control over the aerosol generated by the aerosol-generating device from an aerosol-forming substrate received in the heating cavity. Particularly advantageously, controlling the supply of power to the second heating assembly independent of the supply of power to the first heating assembly may enable a first aerosol-forming substrate arranged in the heating cavity at or around the first portion of the cavity surface to be heated independently of a second aerosol-forming substrate arranged in the heating cavity at or around the second portion of the cavity surface.

The controller may be configured to control the supply of power to the first heating assembly and to control the supply of power to the second heating assembly such that power is supplied to the first heating assembly and the second heating assembly simultaneously.

The controller may be configured to control the supply of power to the first heating assembly and to control the supply of power to the second heating assembly such that power is supplied to the first heating assembly and the second heating assembly such that power is supplied to the first heating assembly only. The controller may be configured to control the supply of power to the first heating assembly and the supply of power to the second heating assembly such that power is supplied to the first heating assembly and the second heating assembly such that power is supplied to the second heating assembly only.

The aerosol-generating device may comprise a power supply. The power supply may be arranged to supply power to the heating assembly.

Where the aerosol-generating device comprises a first heating assembly and a second heating assembly, the power supply may be arranged to supply power to the first heating assembly and the second heating assembly.

The power supply may be any suitable power supply. Preferably, the power supply is a DC power supply. The power supply may be a battery. The power supply may be a rechargeable battery. The battery may be a Lithium based battery, for example a Lithium-Cobalt, a Lithium-Iron-Phosphate, a Lithium Titanate, or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the first heating assembly and the second heating assembly. The power supply may be configured to supply between about 5 puffs and about 12 puffs on the aerosol-generating device. The power supply may be configured to supply between about 8 puffs and about 10 puffs on the aerosol-generating device.

The aerosol-generating device comprises a controller, and may comprise further electronic components. For example, in some embodiments, the controller may comprise any of: sensors, switches, and display elements.

Where the heating assembly is an inductive heating assembly, or at least one of the first heating assembly and the second heating assembly is an inductive heating assembly, and where the power supply is a DC power supply, the aerosol-generating device may comprise a DC/AC converter. The DC/AC converter may enable the aerosol-generating device to supply an alternating current to the inductor coil of an inductive heating assembly. The DC/AC converter may be arranged between the DC power supply and the inductor coil of the inductive heating assembly. The DC/AC converter may comprise a capacitor. The DC/AC converter may comprise a LC (inductor capacitor) load network.

In some preferred embodiments, the DC/AC converter may comprise a capacitor, wherein the DC/AC converter further comprises a LC (inductor capacitor) load network, and wherein the LC load network comprises the inductor coil and the capacitor. In some of these preferred embodiments, the inductor coil is connected in series with the capacitor.

In some preferred embodiments, the DC/AC converter comprises a Class-E power amplifier. The DC/AC converter may comprise a Class-D power amplifier.

In some of these embodiments, the power supply circuit may further comprise a DC/DC converter. The DC/DC converter may be arranged between the DC power supply and the DC/AC converter. The DC/DC converter may enable DC power supplies with different supply voltages to be used with the aerosol-generating device without altering the functioning of the aerosol-generating device.

The power supply circuit may further comprise a puff detector. The puff detector may be configured to detect when a user draws on the aerosol-generating device. The puff detector may be any suitable sensor that is capable of detecting when a user draws on the aerosol-generating device. For example, the puff detector may be an airflow sensor.

Where the power supply circuit comprises a puff detector, the controller may be configured to supply power to the heating assembly to heat aerosol-forming substrate received in the heating cavity when the puff detector detects a user drawing or puffing on the aerosol-generating device.

Where the power supply circuit comprises a puff detector, and where the aerosol-generating device comprises a first heating assembly and a second heating assembly, the controller may be configured to supply power to one or both of the first heating assembly and the second heating assembly to heat aerosol-forming substrate received in the heating cavity when the puff detector detects a user drawing or puffing on the aerosol-generating device.

The aerosol-generating device may comprise a biasing device. The biasing device may be configured to urge the extractor surface in a direction. The biasing device may be configured to urge the extractor surface towards an open proximal end of the heating cavity.

The biasing device may be any suitable biasing device capable of urging the extractor surface in a direction.

The biasing device may comprise a resilient element, such as a spring. The spring may be any suitable type of spring, such as a leaf spring or a coil spring. The spring may be arranged to urge the extractor surface towards an open proximal end of the heating cavity.

The biasing device may comprise magnetic material. The biasing device may comprise a first magnet arranged at the heating cavity. The biasing device may comprise a second magnet arranged at the extractor. The first magnet may be configured to urge the second magnet towards an open proximal end of the heating cavity. The first magnet may comprise a permanent magnet. The first magnet may comprise an electromagnet. The second magnet comprises a permanent magnet. The second magnet may comprise an electromagnet. Where the aerosol-generating device comprises a controller, and wherein at least one of the first magnet and the second magnet comprises an electromagnet, the controller may be configured to control a supply of power to the electromagnet to control the biasing device. The controller may be configured to control a supply of power to the biasing device to control the position of the extractor surface. The controller may be configured to control a supply of power to the biasing device to move the extractor surface between the first position and the second position. Where the extractor is movable between a third position and the first position, the controller may be configured to control a supply of power to the biasing device to move the extractor surface between the third position and the first position.

In some of these embodiments, the biasing device comprises a first magnet and a second magnet, wherein one of the first magnet and the second magnet is an electromagnet, and a resilient element, such as a spring. In these embodiments, the first magnet and the second magnet may be configured to urge the extractor surface in a proximal direction, towards the open proximal end of the heating cavity. In these embodiments, the resilient element may be configured to urge the extractor surface in a distal direction, towards the distal end of the heating cavity. Accordingly, when power is supplied to the electromagnet, the first magnet and the second magnet urge the extractor surface towards the proximal end of the heating cavity, and when power is not supplied to the electromagnet, the resilient element urges the extractor surface towards the distal end of the heating cavity.

The aerosol-generating device may have any suitable form. The aerosol-generating device may be planar, extending in a plane. The aerosol-generating device may be flat. The aerosol-generating device may be a flat, planar aerosol-generating device. Preferably, the aerosol-generating device is substantially cylindrical.

The aerosol-generating device has a transverse cross-sectional shape. The aerosol-generating device may have any suitable transverse cross-sectional shape. For example, the transverse cross-sectional shape of the aerosol-generating device may be circular, oval, rectangular, square or any other regular polygon. Preferably the transverse cross-sectional shape of the aerosol-generating deice is circular.

The aerosol-generating device may have any suitable size. Preferably, the aerosol-generating device is portable. The aerosol-generating device may be a handheld aerosol-generating device. In other words, the aerosol-generating device may be sized and shaped to be held in the hand of a user. The aerosol-generating device may have a size comparable to a conventional cigar or cigarette. The aerosol-generating device may have a length of between approximately 70 millimetres and approximately 120 millimetres.

The aerosol-generating device has an aerosol-generating device length. The aerosol-generating device length may be any suitable length. The aerosol-generating device length may be between about 30 millimetres and about 150 millimetres, between about 70 millimetres and about 120 millimetres, or preferably between about 100 millimetres and about 110 millimetres.

The aerosol-generating device has an aerosol-generating device width. The aerosol-generating device width may be any suitable width. The aerosol-generating device width may be between about 25 millimetres and about 35 millimetres.

The aerosol-generating device has an aerosol-generating device thickness. The aerosol-generating device thickness may be any suitable thickness. The aerosol-generating device thickness may be between about 25 millimetres and about 35 millimetres.

The aerosol-generating device may comprise a housing. The housing may define at least a portion of the heating cavity.

The housing may be planar, extending in a plane. The plane of the housing may be parallel to the plane of the cavity surface. Preferably, the housing is flat. The housing may be a planar, flat housing.

The housing may comprise any suitable material or combination of materials.

The housing may be formed from a non-magnetic material.

As used herein, “non-magnetic material” refers to a material which does not interact with a magnetic field, and is not heatable by penetration with an alternating magnetic field.

In some embodiments, the housing is formed from an electrically insulative material.

As used herein, “thermally insulative” refers to a material having a bulk thermal conductivity of less than about 5 Watts per metre Kelvin (mW/(m K)) at 23 degrees Celsius (°C) and a relative humidity of 50 percent as measured using the modified transient plane source (MTPS) method.

In some embodiments, the housing is formed from an electrically insulative material.

As used herein, “electrically insulative” refers to a material having a volume resistivity at 20 degrees Celsius (°C) of greater than about 1×10⁶ ohm-metres (Ωm), typically between about 1×10⁹ ohm-metres (Ωm) and about 1×10²¹ ohm-metres (Ωm).

Preferably, the material is light and non-brittle.

Examples of suitable materials include metals, alloys, plastics or composite materials containing one or more of those materials, or thermoplastics that are suitable for food or pharmaceutical applications, for example polypropylene, polyetheretherketone (PEEK) and polyethylene.

According to the present disclosure there is provided an aerosol-generating system. The aerosol-generating system may comprise an aerosol-generating device as described above. The aerosol-generating system may comprise an aerosol-forming substrate.

According to the present disclosure there is provided an aerosol-generating system comprising an aerosol-generating device as described above and an aerosol-forming substrate.

The aerosol-generating system may be configured to deliver nicotine or cannabinoids to a user.

The aerosol-generating system comprises an aerosol-forming substrate. The aerosol-forming substrate may take any suitable form. The aerosol-forming substrate may be substantially planar, extending in a plane. The aerosol-forming substrate may be substantially flat. The aerosol-forming substrate may be a substantially flat, planar aerosol-generating article.

The aerosol-forming substrate has a transverse cross-sectional shape. The aerosol-forming substrate may have any suitable transverse cross-sectional shape. The aerosol-forming substrate may have a transverse cross-sectional shape that is circular, oval, square, rectangular, or any other regular polygon. Preferably, the transverse cross-sectional shape of the aerosol-forming substrate is substantially circular.

In some preferred embodiments, the aerosol-forming substrate is a flat, planar disc.

In some preferred embodiments, the aerosol-forming substrate is comprised in an aerosol-generating article.

The aerosol-generating article may take any suitable form. The aerosol-generating article may be substantially planar, extending in a plane. The aerosol-generating article may be substantially flat. The aerosol-generating article may be a substantially flat, planar aerosol-generating article.

The aerosol-generating article has a transverse cross-sectional shape. The aerosol-generating article may have any suitable transverse cross-sectional shape. The aerosol-generating article may have a transverse cross-sectional shape that is circular, oval, square, rectangular, or any other regular polygon. Preferably, the transverse cross-sectional shape of the aerosol-generating article is substantially circular.

In some preferred embodiments, the aerosol-generating article is a flat, planar disc.

The aerosol-generating article may have any suitable size.

The heating cavity of the aerosol-generating device may be configured to receive the aerosol-generating article when the extractor surface is in the second position. The aerosol-generating article may have substantially the same shape and size as the heating cavity of the aerosol-generating device when the extractor surface is in the second position. Where the extractor surface of the aerosol-generating device is movable between the first position and a third position, the heating cavity may be configured to receive two aerosol-generating articles when the extractor surface is in the third position. The aerosol-generating article may have a thickness that is about half of the depth of the heating cavity of the aerosol-generating device when the extractor surface is in the third position.

The aerosol-generating article has an article length. The article length may be any suitable article length. The article length may be between about 4 millimetres and about 22 millimetres. The aerosol-generating article has an article width. The article width may be any suitable article width. The article width may be between about 4 millimetres and about 22 millimetres. The aerosol-generating article has an article thickness. The article thickness may be any suitable article thickness. The article thickness may be between about 0.7 millimetres and about 7.5 millimetres.

In some embodiments, the aerosol-generating article comprises a susceptor element. Where the heating assembly of the aerosol-generating device is an inductive heating assembly and the inductive heating assembly does not comprise a heating element, the aerosol-generating article may comprise a susceptor element.

The susceptor element may be arranged to heat the aerosol-forming substrate. The susceptor element may be arranged to be penetrated by the varying magnetic field generated by the inductor coil of the inductive heating assembly of the aerosol-generating device when the aerosol-generating article is received in the heating cavity.

The susceptor element may be any suitable susceptor element, as described above. The susceptor element may have the same shape as the aerosol-forming substrate. The susceptor element may be a flat, planar disc.

Where the aerosol-generating article comprises a first aerosol-forming substrate and a second aerosol-forming substrate, the aerosol-generating article may comprise a first susceptor arranged to heat the first aerosol-forming substrate. Where the aerosol-generating article comprises a first aerosol-forming substrate and a second aerosol-forming substrate, the aerosol-generating article may comprise a second susceptor arranged to heat the second aerosol-forming substrate.

Where the first heating assembly of the aerosol-generating device is an inductive heating assembly and the first inductive heating assembly does not comprise a first heating element, the aerosol-generating article may comprise a first susceptor element. Where the second heating assembly of the aerosol-generating device is an inductive heating assembly and the second inductive heating assembly does not comprise a second heating element, the aerosol-generating article may comprise a second susceptor element.

The first susceptor element may have the same shape as the first aerosol-forming substrate. The second susceptor element may have the same shape as the second aerosol-forming substrate.

The aerosol-generating article may comprise a housing. The housing may define a substrate cavity. The aerosol-forming substrate may be arranged in the substrate cavity. Preferably the housing is a wrapper. In some embodiments, the aerosol-generating article comprises a wrapper circumscribing the aerosol-forming substrate. The wrapper may be formed of any suitable material. Preferably, the wrapper is formed from cigarette paper.

In some embodiments, the aerosol-generating system comprises a first aerosol-forming substrate and a second aerosol-forming substrate. In particular, where the aerosol-generating device comprises a first heating assembly and a second heating assembly, the aerosol-generating system may comprise a first aerosol-forming substrate and a second aerosol-forming substrate. The aerosol-generating article may comprise the first aerosol-forming substrate and the second aerosol-forming substrate.

Where the aerosol-generating article comprises a first aerosol-forming substrate and a second aerosol-forming substrate, the first aerosol-forming substrate may be the same as the second aerosol-forming substrate. Preferably, the second aerosol-forming substrate is different to the first aerosol-forming substrate.

Where the aerosol-generating system comprises a first aerosol-forming substrate and a second aerosol-forming substrate, the aerosol-generating system may comprise an aerosol-generating article comprising the first aerosol-forming substrate and the second aerosol-forming substrate.

The aerosol-generating article may be configured such that the first aerosol-forming substrate is heated by the first heating assembly when the aerosol-generating article is received in the heating cavity. The aerosol-generating article may be configured such that the second aerosol-forming substrate is heated by the second heating assembly when the aerosol-generating article is received in the heating cavity.

The first aerosol-forming substrate may be a planar aerosol-forming substrate extending in a first plane. The second aerosol-forming substrate may be a planar aerosol-forming substrate extending in a second plane. The second plane of the second planar aerosol-forming substrate may be parallel to the first plane of the first planar aerosol-forming substrate. The second plane of the second planar aerosol-forming substrate may be the first plane of the first planar aerosol-forming substrate.

In some preferred embodiments, the first aerosol-forming substrate is a first planar aerosol-forming substrate extending in a plane; and the second aerosol-forming substrate is a second planar aerosol-forming substrate extending in the plane of the first aerosol-forming substrate, and circumscribing the first aerosol-forming substrate. The second aerosol-forming substrate may be arranged concentrically with the first aerosol-forming substrate.

In some particularly preferred embodiments, the first aerosol-forming substrate is a flat, planar disc, and the second aerosol-forming substrate is a flat, planar ring, circumscribing the first aerosol-forming substrate.

Where the aerosol-generating device comprises a first heating assembly comprising a first planar heating element extending in a plane; and a second heating assembly comprising a second planar heating element extending in the plane of the first heating element, and circumscribing the first heating element, the first aerosol-forming substrate may have substantially the same shape, length and width as the first heating element, and the second aerosol-forming substrate may have substantially the same shape, length and width as the second heating element.

Where the aerosol-generating system comprises a first heating assembly and a second heating assembly, the first aerosol-forming substrate may be configured to be heated by the first heating assembly and the second aerosol-forming substrate may be configured to be heated by the second heating assembly.

Where the first heating assembly comprises a first heating element, the first aerosol-forming substrate may be configured to be heated by the first heating element when the aerosol-generating article is received in the heating cavity.

Where the second heating assembly comprises a second heating element, the second aerosol-forming substrate may be configured to be heated by the second heating element when the aerosol-generating article is received in the heating cavity.

Where the first heating assembly comprises a first inductor coil, and does not comprise a first heating element, the aerosol-generating article may comprise a first heating element in the form of a susceptor element. The first heating element may be arranged in the aerosol-generating article to heat the first aerosol-forming substrate. The first heating element may be arranged to be penetrated by the first varying magnetic field generated by the first inductor coil when the aerosol-generating article is received in the heating cavity.

Where the second heating assembly comprises a second inductor coil, and does not comprise a second heating element, the aerosol-generating article may comprise a second heating element in the form of a susceptor element. The second heating element may be arranged in the aerosol-generating article to heat the second aerosol-forming substrate. The second heating element may be arranged to be penetrated by the second varying magnetic field generated by the second inductor coil when the aerosol-generating article is received in the heating cavity.

The aerosol-generating device is configured to receive an aerosol-forming substrate. The aerosol-forming substrate may be any suitable aerosol-forming substrate.

The aerosol-forming substrate may be a solid aerosol-forming substrate. The aerosol-forming substrate may be a liquid aerosol-forming substrate.

The aerosol-forming substrate may comprise tobacco. The aerosol-forming substrate may be a solid aerosol-forming substrate comprising tobacco. The aerosol-forming substrate may comprise a tobacco-containing material containing volatile tobacco flavour compounds, which are released from the substrate upon heating.

The solid aerosol-forming substrate may comprise a plug of tobacco. The plug of tobacco may comprise, for example, one or more of: powder, granules, pellets, shreds, strands, strips or sheets containing one or more of: herb leaf, tobacco leaf, tobacco ribs, expanded tobacco and homogenised tobacco. As used herein, ‘homogenised tobacco material’ denotes a material formed by agglomerating particulate tobacco. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating. Where the tobacco plug comprises homogenised tobacco material, the homogenised tobacco material may be in the form of a sheet. As used herein, ‘sheet’ denotes a laminar element having a width and length substantially greater than the thickness thereof.

The solid aerosol-forming substrate may comprise homogenised tobacco material. The solid aerosol-forming material may comprise shreds, strands or strips of homogenised tobacco material. The solid aerosol-forming substrate may comprise a sheet of homogenised tobacco material.

Sheets of homogenised tobacco material may be formed by agglomerating particulate tobacco obtained by grinding or otherwise comminuting one or both of tobacco leaf lamina and tobacco leaf stems. Sheets of homogenised tobacco material may comprise one or more of tobacco dust, tobacco fines and other particulate tobacco by-products formed during, for example, the treating, handling and shipping of tobacco. Sheets of homogenised tobacco material are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

The solid aerosol-forming substrate may comprises a gathered sheet of homogenised tobacco material. As used herein, ‘gathered’ is used to describe a sheet that is convoluted, folded, or otherwise compressed or constricted substantially transversely to a longitudinal axis of the aerosol-generating article.

In some preferred embodiments, the aerosol-forming substrate comprises a gathered textured sheet of homogenised tobacco material. As used herein, ‘textured sheet’ denotes a sheet that has been crimped, embossed, debossed, perforated or otherwise deformed. Use of a textured sheet of homogenised tobacco material may advantageously facilitate gathering of the sheet of homogenised tobacco material to form the aerosol-forming substrate. The aerosol-forming substrate may comprise a gathered textured sheet of homogenised tobacco material comprising a plurality of spaced-apart indentations, protrusions, perforations or a combination thereof.

In a particularly preferred embodiment, the aerosol-forming substrate comprises a gathered crimped sheet of homogenised tobacco material. As used herein, ‘crimped sheet’ denotes a sheet having a plurality of substantially parallel ridges or corrugations. Preferably, the substantially parallel ridges or corrugations extend along or parallel to a longitudinal axis of the aerosol-generating article. This advantageously facilitates gathering of the crimped sheet of homogenised tobacco material to form the aerosol-generating article. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article.

The aerosol-forming substrate may comprise tobacco-containing material and non-tobacco containing material.

The aerosol-forming substrate may comprise an aerosol former. The aerosol-forming substrate may comprise a single aerosol former or a combination of two or more aerosol formers. As used herein, the term ‘aerosol former’ is used to describe any suitable known compound or mixture of compounds that, in use, facilitates formation of an aerosol and that is substantially resistant to thermal degradation at the operating temperature of the aerosol-generating article. Suitable aerosol-formers include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine. The aerosol-forming substrate may have an aerosol former content of greater than 5 percent on a dry weight basis. The aerosol aerosol-forming substrate may have an aerosol former content of between approximately 5 percent and approximately 30 percent on a dry weight basis. The aerosol-forming substrate may have an aerosol former content of approximately 20 percent on a dry weight basis.

The aerosol-forming substrate preferably comprises homogenised tobacco material, an aerosol-former and water.

The homogenised tobacco material may be provided in sheets, which are one of folded, crimped, or cut into strips. In a particularly preferred embodiment, the sheets are cut into strips having a width of between about 0.2 millimetres and about 2 millimetres, more preferably between about 0.4 millimetres and about 1.2 millimetres. In one embodiment, the width of the strips is about 0.9 millimetres.

In some embodiments, the aerosol-forming substrate is a gel. Advantageously, the gel is solid at room temperature. As used herein, a “solid gel” refers to a gel that has a stable size and shape and does not flow at room temperature. As used herein, “room temperature” refers to 25 degrees Celsius.

Where the aerosol-forming substrate is a gel, advantageously the gel may be a thermoreversible gel. This means that the gel will become fluid when heated to a melting temperature and will set into a gel again at a gelation temperature. The gelation temperature is preferably at or above room temperature and atmospheric pressure. Atmospheric pressure means a pressure of 1 atmosphere. The melting temperature is preferably higher than the gelation temperature. Preferably the melting temperature of the gel is above 50 degrees Celsius, or 60 degrees Celsius or 70 degrees Celsius and more preferably above 80 degrees Celsius. The melting temperature in this context means the temperature at which the gel is no longer solid and begins to flow. The gel may comprise a gelling agent. Preferably, the gel comprises agar or agarose or sodium alginate. The gel may comprise Gellan gum. The gel may comprise a mixture of materials. The gel may comprise water.

The gel may be provided as a single block or may be provided as a plurality of gel elements, for example beads or capsules. The use of capsules or beads may allow a user to see when a cartridge has already been used because gel will not form the same capsules or beads on gelation after heating and subsequent cooling.

The gel may comprise nicotine or a tobacco product or another target compound for delivery to a user. When the resulting aerosol is to contain nicotine, it is advantageous for the nicotine to be contained in the gel or in another solid form in the substrate container rather than in a liquid. The nicotine can be included in the gel with an aerosol-former. Nicotine is irritating to the skin and can be toxic. Preventing any possible leakage of nicotine by locking the nicotine into a gel at room temperature is therefore desirable.

When agar is used as the gelling agent, the gel preferably comprises between 0.5 and 5% by weight (and more preferably between 0.8and 1 % by weight) agar. The gel may further comprise between 0.1 and 2% by weight nicotine. The gel may further comprise between 30% and 90% by weight (and more preferably between 70 and 90% by weight) glycerin. A remainder of the gel may comprise water and any flavourings.

When Gellan gum is used as the gelling agent, the gel preferably comprises between 0.5 and 5% by weight Gellan gum. The gel may further comprise between 0.1 and 2% by weight nicotine. The gel may further comprise between 30% and 99.4% by weight gylcerin. A remainder of the gel may comprise water and any flavourings.

In one embodiment, the gel comprises 2% by weight nicotine, 70% by weight glycerol, 27% by weight water and 1% by weight agar. In another embodiment, the gel comprises 65% by weight glycerol, 20% by weight water, 14.3% by weight tobacco and 0.7% by weight agar.

Where the aerosol-generating system comprises a first aerosol-forming substrate and a second aerosol-forming substrate, the composition of the first aerosol-forming substrate and the composition of the second aerosol-forming substrate may be different. Advantageously, providing a first aerosol-forming substrate and a second aerosol-forming substrate with different compositions may enable the aerosol-generating system to vary the aerosol generated by the aerosol-generating system. This may enable a user to customise the aerosol-generating experience from the aerosol-generating system.

The invention is defined in the claims. However, below there is provided a first non-exhaustive list of non-limiting examples. Any one or more of the features of these examples may be combined with any one or more features of another example, embodiment, or aspect described herein.
1. An aerosol-generating device comprising:
a heating cavity configured to receive an aerosol-forming substrate;
a heating assembly arranged in the heating cavity; and
an extractor comprising an extractor surface movable within the heating cavity, wherein at least a portion of the extractor surface is formed by a portion of the heating assembly.
2. An aerosol-generating device according to example Ex 1, wherein the heating cavity has a longitudinal axis, and wherein the extractor surface is movable along the longitudinal axis of the heating cavity.
3. An aerosol-generating device according to example Ex 1 or Ex 2, wherein the extractor surface is slidable or translatable within the heating cavity.
4. An aerosol-generating device according to any one of examples Ex 1 to Ex 3, wherein the heating cavity has a proximal end and a distal end opposite the proximal end, and wherein the proximal end is substantially open.
5. An aerosol-generating device according to example Ex 4, wherein the extractor surface is movable in a proximal direction towards the proximal end of the heating cavity from a first position to a second position, and wherein the extractor surface is movable in a distal direction towards the distal end of the heating cavity from the second position to the first position.
6. An aerosol-generating device according to example Ex 5, wherein the first position is a heating position, in which an aerosol-forming substrate is able to be received in the heating cavity and heated by the heating assembly; and wherein the second position is an extraction position, in which an aerosol-forming substrate received in the heating cavity is located at, around or outside the open proximal end of the heating cavity, and optionally wherein in the second position the extractor surface is arranged at the open proximal end of the heating cavity or outside of the heating cavity.
7. An aerosol-generating device according to example Ex 5 or Ex 6, wherein the extractor surface is movable in a distal direction towards the distal end of the heating cavity from the first position to a third position, and wherein the extractor surface is movable in a proximal direction towards the proximal end of the heating cavity from the third position to the first position.
8. An aerosol-generating device according to example Ex 7, wherein the third position is an additional heating position, in which a greater volume of aerosol-forming substrate is able to be received in the heating cavity and heated by the heating assembly compared to when the extractor surface is in the first position.
9. An aerosol-generating device according to any one of examples Ex 1 to Ex 8, wherein a surface of the heating cavity is defined by the extractor surface, and optionally wherein the extractor surface defines a distal end surface of the heating cavity.
10. An aerosol-generating device according to any one of examples Ex 1 to Ex 9, wherein the heating assembly comprises a heating element, and wherein a surface of the heating element forms at least a portion of the extractor surface.
11. An aerosol-generating device according to example Ex 10, wherein the heating element is a resistive heating element.
12. An aerosol-generating device according to example Ex 10, wherein the heating assembly further comprises an inductor coil.
13. An aerosol-generating device according to example Ex 12, wherein the inductor coil is a planar inductor coil.
14. An aerosol-generating device according to example Ex 12 or Ex 13, wherein the inductor coil is movable with the extractor surface of the extractor.
15. An aerosol-generating device according to any one of examples Ex 12 to Ex 14, wherein the inductor coil is arranged beneath the heating element.
16. An aerosol-generating device according to any one of examples Ex 12 to Ex 15, wherein the heating element is a susceptor element.
17. An aerosol-generating device according to example Ex 16, wherein the inductor coil generates a varying magnetic field when a varying current is supplied to the inductor coil, and wherein the susceptor element is arranged to be penetrated by the varying magnetic field generated by the inductor coil.
18. An aerosol-generating device according to example Ex 16 or Ex 17, wherein the susceptor element comprises a magnetic material that is heatable by penetration with a varying magnetic field, and optionally wherein the susceptor element comprises at least about 5 percent, or at least about 20 percent, or at least about 50 percent, or at least about 90 percent of ferromagnetic or paramagnetic materials on a dry weight basis.
19. An aerosol-generating device according to example Ex 18, wherein the magnetic material is a ferromagnetic material, such as ferrite, ferritic iron, a ferromagnetic alloy, a ferromagnetic steel, or a ferromagnetic stainless steel such as SAE 400 series stainless steels, SAE type 409, 410, 420 or 430 stainless steels.
20 An aerosol-generating device according to any one of examples Ex12 to Ex19, wherein the heating assembly further comprises a shielding element.
21. An aerosol-generating device according to example Ex 20, wherein the inductor coil is arranged between the heating element and the shielding element.
22. An aerosol-generating device according to example Ex 20 or Ex 21, wherein the shielding element is formed from a material having a relative magnetic permeability of at least 5, or at least 10, or at least 20, or at least 30, or at least 40, or at least 50, or at least 60, or at least 80, or at least 100 for a frequency of between 6 and 8 megahertz (MHz) and a temperature of 25 degrees Celsius.
23. An aerosol-generating device according to any one of examples Ex 20 to Ex 22, wherein the first shielding element comprises a magnetic material, and optionally wherein the first shielding element comprises at least about 5 percent, or at least about 20 percent, or at least about 50 percent, or at least about 90 percent of ferromagnetic or paramagnetic materials on a dry weight basis.
24. An aerosol-generating device according to any one of examples Ex 1 to Ex 23, wherein the extractor surface is planar, extending substantially in a plane.
25. An aerosol-generating device according to any one of examples Ex 1 to Ex 24, wherein the extractor surface is substantially circular, and optionally wherein the heating cavity is substantially cylindrical.
26 An aerosol-generating device according to any one of examples Ex 1 to Ex 25, wherein the heating assembly is a first heating assembly and the heating element of the first heating assembly is a first planar heating element extending in a plane, and wherein the aerosol-generating device comprises a second heating assembly comprising a second planar heating element extending in the plane of the first heating element, and circumscribing the first heating element.
27. An aerosol-generating device according to example Ex 26, wherein the first heating element is substantially circular, and the second heating element forms a ring circumscribing the first heating element.
28. An aerosol-generating device according to example Ex 26 or Ex 27, wherein the first heating element is a resistive heating element.
29 An aerosol-generating device according to any one of examples Ex 26 to Ex 28, wherein the second heating element is a resistive heating element.
30. An aerosol-generating device according to any one of examples Ex 26, Ex 27 or Ex29, wherein the first heating element is a susceptor element.
31. An aerosol-generating device according to example Ex 30, wherein the first heating assembly comprises a first inductor coil, wherein the first inductor coil generates a varying magnetic field when a varying current is supplied to the first inductor coil, and wherein the first heating element is arranged to be penetrated by the varying magnetic field generated by the first inductor coil.
32. An aerosol-generating device according to any one of examples Ex 26 to Ex 28, wherein the second heating element is a susceptor element.
33. An aerosol-generating device according to example Ex 32, wherein the second heating assembly comprises a second inductor coil, wherein the second inductor coil generates a varying magnetic field when a varying current is supplied to the second inductor coil, and wherein the second heating element is arranged to be penetrated by the varying magnetic field generated by the second inductor coil.
34 An aerosol-generating device according to example Ex 26 or Ex 27, wherein the first heating element is a first susceptor element, and the second heating element is a second susceptor element.
35. An aerosol-generating device according to example Ex 34, wherein:
the first heating assembly comprises a first inductor coil, wherein the first inductor coil generates a varying magnetic field when a varying current is supplied to the first inductor coil, and wherein the first heating element is arranged to be penetrated by the varying magnetic field generated by the first inductor coil; and
the second heating assembly comprises a second inductor coil, wherein the second inductor coil generates a varying magnetic field when a varying current is supplied to the second inductor coil, and wherein the second heating element is arranged to be penetrated by the varying magnetic field generated by the second inductor coil.
36 An aerosol-generating device according to any one of examples Ex 1 to Ex 35, wherein the heating assembly is movable within the heating cavity with the extractor surface.
37. An aerosol-generating device according to any one of examples Ex 1 to Ex 36, further comprising a biasing device configured to urge the extractor surface towards an open proximal end of the heating cavity.
38. An aerosol-generating device according to example Ex 37, wherein the biasing device comprises a resilient element, such as a spring.
39 An aerosol-generating device according to examples Ex 37 or Ex 38, wherein the biasing device comprises a first magnet arranged at the heating cavity and a second magnet arranged at the extractor, and wherein the first magnet is configured to urge the second magnet towards the open proximal end of the heating cavity.
40. An aerosol-generating device according to example Ex 39, wherein the first magnet comprises at least one of a permanent magnet and an electromagnet.
41. An aerosol-generating device according to example Ex 39 or Ex 40, wherein the second magnet comprises at least one of a permanent magnet and an electromagnet.
42. An aerosol-generating system comprising:
an aerosol-generating device according to any one of examples Ex1 to Ex41; and
an aerosol-forming substrate.
43. An aerosol-generating system according to example Ex 42, further comprising an aerosol-generating article comprising the aerosol-forming substrate. 44. An aerosol-generating system according to example Ex 43, wherein the aerosol-generating article is substantially planar.

45. An aerosol-generating system according to example Ex 43 or Ex 44, wherein the aerosol-generating article is substantially circular, and optionally wherein the aerosol-generating article is a circular, planar disc.

The invention is defined in the claims. However, below there is provided a second non-exhaustive list of non-limiting examples. Any one or more of the features of these examples may be combined with any one or more features of another example, embodiment, or aspect described herein.
1. An aerosol-generating device comprising:
a first heating assembly comprising a first planar heating element extending in a plane; and
a second heating assembly comprising a second planar heating element extending in the plane of the first heating element, and circumscribing the first heating element.
2. An aerosol-generating device according to example Ex 1, wherein the first heating element is substantially circular, and the second heating element forms a ring circumscribing the first heating element.
3. An aerosol-generating device according to example Ex 1 or Ex 2, wherein the first heating element is a resistive heating element.
4. An aerosol-generating device according to any one of examples Ex 1 to Ex 3, wherein the second heating element is a resistive heating element.
5. An aerosol-generating device according to any one of examples Ex 1, Ex 2 or Ex 4, wherein the first heating element is a susceptor element.
6. An aerosol-generating device according to example Ex 5, wherein the first heating assembly comprises a first inductor coil, wherein the first inductor coil generates a varying magnetic field when a varying current is supplied to the first inductor coil, and wherein the first heating element is arranged to be penetrated by the varying magnetic field generated by the first inductor coil.
7. An aerosol-generating device according to any one of examples Ex 1 to Ex 3, wherein the second heating element is a susceptor element.
8. An aerosol-generating device according to example Ex 7, wherein the second heating assembly comprises a second inductor coil, wherein the second inductor coil generates a varying magnetic field when a varying current is supplied to the second inductor coil, and wherein the second heating element is arranged to be penetrated by the varying magnetic field generated by the second inductor coil.
9. An aerosol-generating device according to example Ex 1 or Ex 2, wherein the first heating element is a first susceptor element, and the second heating element is a second susceptor element.
10. An aerosol-generating device according to example Ex 9, wherein:
the first heating assembly comprises a first inductor coil, wherein the first inductor coil generates a varying magnetic field when a varying current is supplied to the first inductor coil, and wherein the first heating element is arranged to be penetrated by the varying magnetic field generated by the first inductor coil; and
the second heating assembly comprises a second inductor coil, wherein the second inductor coil generates a varying magnetic field when a varying current is supplied to the second inductor coil, and wherein the second heating element is arranged to be penetrated by the varying magnetic field generated by the second inductor coil.
11. An aerosol-generating device according to example Ex 9, wherein the first heating assembly comprises an inductor coil, wherein the inductor coil generates a varying magnetic field when a varying current is supplied to the inductor coil, and wherein the first heating element is arranged to be penetrated by the varying magnetic field generated by the inductor coil, and the second heating assembly comprises the inductor coil, and wherein the second heating element is arranged to be penetrated by the varying magnetic field generated by the inductor coil.
12. An aerosol-generating device according to any one of examples Ex 1 to Ex 11, wherein the first heating element is formed from the same material as the second heating element.
13. An aerosol-generating device according to any one of examples Ex 1 to Ex 11, wherein the first heating element is formed from a different material to the second heating element.
14. An aerosol-generating device according to any one of examples Ex 1 to Ex 13, wherein the first heating element is configured to be heated to a first temperature, and wherein the second heating element is configured to be heated to a second temperature, different to the first temperature.
15. An aerosol-generating device further comprising a controller, wherein the controller is configured to control a supply of power to the first heating assembly to heat the first heating element, wherein the controller is configured to control a supply of power to the second heating assembly to heat the second heating element, and wherein the supply of power to the first heating assembly is independent of the supply of power to the second heating assembly.
16. An aerosol-generating device according to example Ex 15, wherein the controller is further configured to control the supply of power to the first heating assembly to heat the first heating element to a first operating temperature, and wherein the controller is further configured to control the supply of power to the second heating assembly to heat the second heating element to a second operating temperature, the second operating temperature being different to the first operating temperature.
17. An aerosol-generating system comprising:
an aerosol-generating device according to any one of examples Ex1 to Ex16; and
an aerosol-forming substrate.
18. An aerosol-generating system according to example Ex 17, further comprising an aerosol-generating article comprising the aerosol-forming substrate.
19. An aerosol-generating system according to example Ex 18, wherein the aerosol-generating article is substantially planar.
20. An aerosol-generating system according to example Ex 18 or Ex 19, wherein the aerosol-generating article is substantially circular, and optionally wherein the aerosol-generating article is a circular, planar disc.
21 An aerosol-generating system according to any one of examples Ex18 to Ex20, wherein the aerosol-generating article comprises a first aerosol-forming substrate, and a second aerosol-forming substrate.
22 An aerosol-generating system according to example Ex21, wherein the first aerosol-forming substrate is a first planar aerosol-forming substrate extending in a plane; and the second aerosol-forming substrate is a second planar aerosol-forming substrate extending in the plane of the first aerosol-forming substrate, and circumscribing the first aerosol-forming substrate.
23. An aerosol-generating system according to example Ex 21 or Ex 22, wherein the first aerosol-forming substrate is configured to be heated by the first heating element, and the second aerosol-forming substrate is configured to be heated by the second heating element.
24. An aerosol-generating system according to any one of examples Ex 17 to Ex 23, wherein the aerosol-generating device further comprises a heating cavity configured to receive the aerosol-forming substrate, and optionally wherein the first planar heating element and the second planar heating element form at least a portion of a surface of the heating cavity.
25 An aerosol-generating system according to example Ex 24, wherein the heating cavity has a proximal end and a distal end opposite the proximal end, wherein the proximal end is substantially open, and wherein the first planar heating element and the second planar heating element form at least a portion of a surface of the heating cavity at the distal end.

Examples will now be further described with reference to the figures in which:

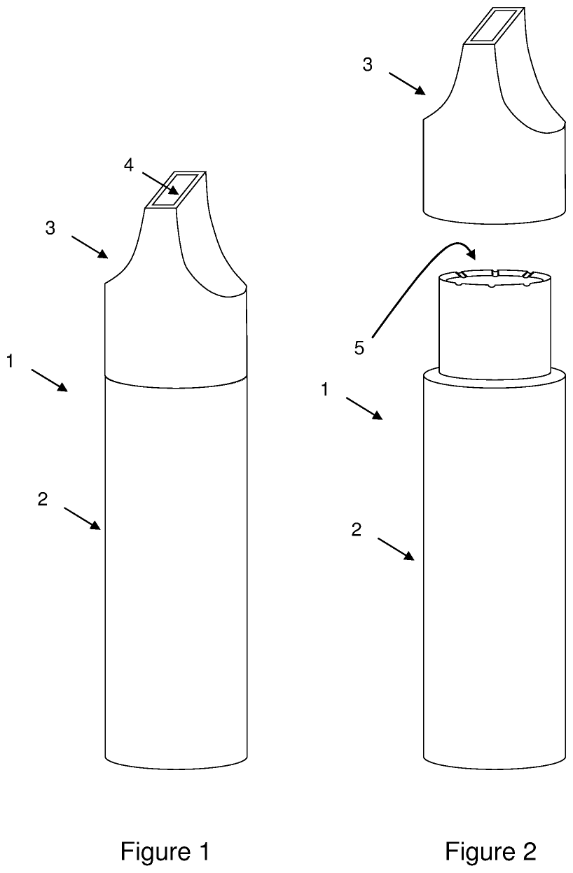

FIG. 1 shows a schematic illustration of an aerosol-generating device according to the present disclosure;

FIG. 2 shows a schematic illustration of the aerosol-generating device of FIG. 1, with the mouthpiece removed;

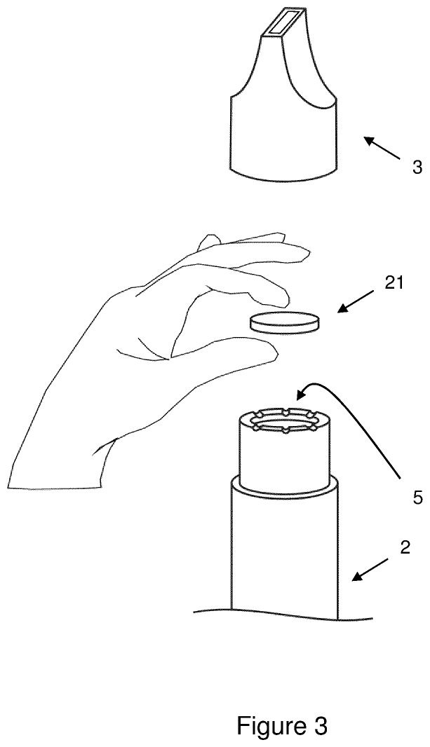

FIG. 3 shows a schematic illustration of an aerosol-generating system according to the present disclosure, comprising the aerosol-generating device of FIG. 1 and an aerosol-generating article;

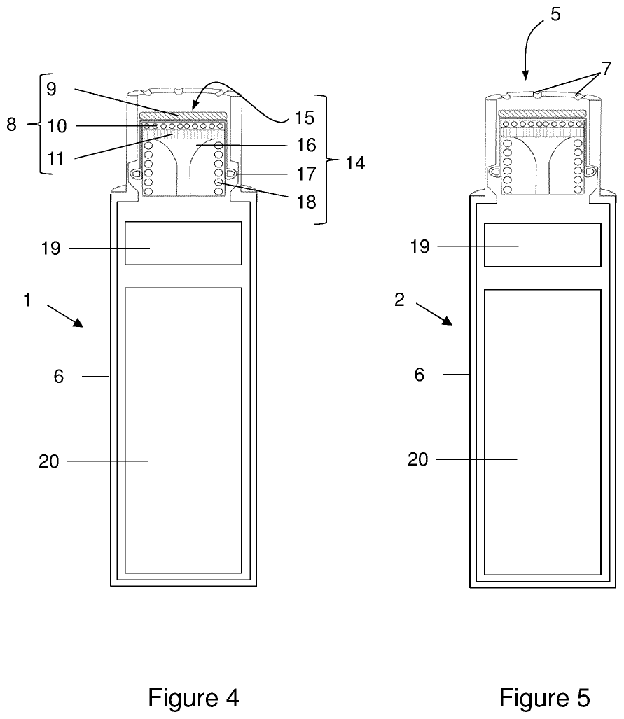

FIG. 4 shows a schematic illustration of the aerosol-generating device of FIG. 1 with the extractor in a heating position;

FIG. 5 shows a schematic illustration of the aerosol-generating device of FIG. 1 with the extractor in an extraction position;

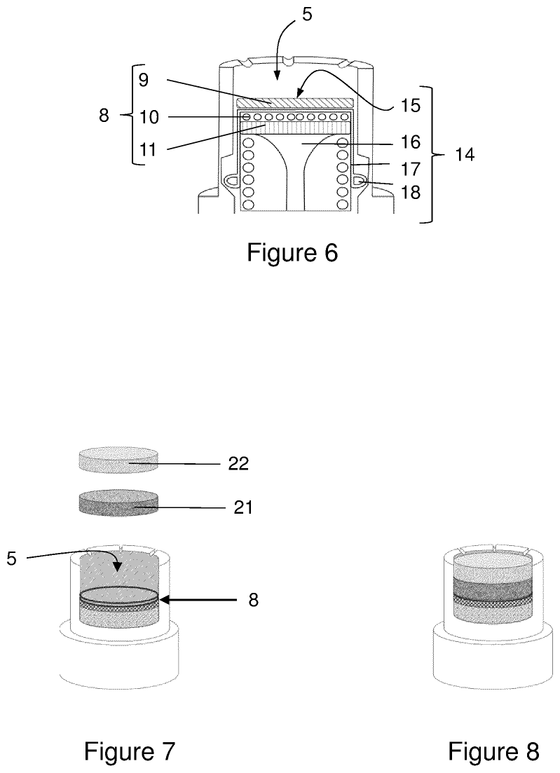

FIG. 6 shows a schematic illustration of a portion of the aerosol-generating device of FIG. 1 with the extractor in a second heating position;

FIG. 7 shows a schematic illustration of a portion of the aerosol-generating system of FIG. 3 including two aerosol-generating articles;

FIG. 8 shows a schematic illustration of a portion of the aerosol-generating system of FIG. 3 with two aerosol-generating articles received in the heating cavity; and

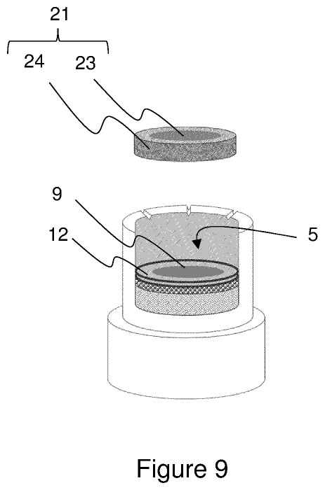

FIG. 9 shows a schematic illustration of another embodiment of a portion of an aerosol-generating device according to the present disclosure.

FIG. 1 shows a schematic illustration of an aerosol-generating device 1 according to this disclosure. The aerosol-generating device 1 comprises a main body 2 and a mouthpiece 3 that is removably receivable on the main body 2. The mouthpiece 3 comprises a mouthpiece opening 4 that enables aerosol generated by the aerosol-generating device 1 to be delivered to a user.

The main body 2 of the aerosol-generating device 1 comprises a heating cavity 5, as shown in FIG. 2. The heating cavity 5 is configured to receive an aerosol-forming substrate, as described in more detail later on. The heating cavity 5 is defined by a housing 6 of the main body 2, as shown in more detail in FIGS. 4 and 5. The heating cavity 5 is substantially cylindrical, having a circular transverse cross-sectional shape. The heating cavity 5 has an open proximal end. The open proximal end of the heating cavity 5 enables an aerosol-forming substrate to be inserted into the heating cavity 5 and removed from the heating cavity 5. The heating cavity 5 also has a substantially closed distal end, opposite the proximal end. At the open proximal end of the heating cavity 5, the heating cavity 5 is provided with a plurality of air inlets 7, in the form of notches or grooves in the housing 6.

The air inlets 7 at the open proximal end of the heating cavity 5 enable ambient air to be drawn into the heating cavity 5. When the mouthpiece 3 is arranged over the heating cavity 5, as shown in FIG. 1, an opening is formed at the interface between the mouthpiece 3 and the housing 6 of the main body 3, and an airflow path is defined between the opening at the interface and the heating cavity 5. The airflow path extends from the opening at the interface between the mouthpiece 3 and the housing 6 of the main body 2 in a proximal direction, between the mouthpiece 3 and the outer face of the housing 6 of the main body 2. The airflow path ends at the air inlets 7 at the proximal end of the heating cavity. The air inlets 7 are inclined distally to direct air from the airflow path into the heating cavity 5 and towards an aerosol-forming substrate received in the heating cavity 5.

The aerosol-generating device 1 further comprises a heating assembly 8 arranged in the heating cavity 5. In this embodiment, the heating assembly 8 is an inductive heating assembly. The inductive heating assembly 8 comprises a heating element 9, in the form of a susceptor element, an inductor coil 10, and a shielding element 11.

The heating assembly 8 comprises a laminar structure comprising the inductor coil 10 arranged between the susceptor element 9 and the shielding element 11. The heating assembly 8 is a substantially flat, planar assembly.

The heating element 9 is a flat, planar heating element, extending in a plane. The heating element 9 generally has the form of a circular disc. The heating element 9 is a susceptor element that is heatable by penetration with a varying magnetic field. In this embodiment, the susceptor element 9 is formed from a ferromagnetic stainless steel.

The inductor coil 10 is a flat, planar inductor coil, extending in a plane parallel to the plane of the heating element 9. The inductor coil 10 is a circular coil, having substantially circular turns. The susceptor element 9 and the inductor coil 10 are arranged such that a varying current supplied to the inductor coil 10 generates a varying magnetic field that penetrates and heats the susceptor element 9.

The shielding element 11 is a flat, planar shielding element, extending in a plane parallel to the plane of the heating element 9. The shielding element 11 is formed from copper alloy 770. The shielding element 11 is intended to protect electrical components arranged behind the heating assembly 8 from the varying magnetic field generated by the inductor coil 10 when a varying current is supplied to the inductor coil 10. A further shielding element (not shown) comprised of a thermally insulative material may also be arranged behind the shielding element 11 to further protect components arranged behind the heating assembly from heat generated by the heating assembly.

The aerosol-generating device 1 further comprises an extractor 14. The extractor 14 is arranged in the heating cavity 5. The extractor 14 comprises an extractor surface 15, which in this embodiment is formed by a surface of the susceptor element 9. The extractor surface 15 forms a distal end of the heating cavity 5. Accordingly, the position of the extractor surface 15 defines the depth of the heating cavity 5.

The extractor surface 15 is movable within the heating cavity 5. The heating cavity 5 has a longitudinal axis, and the extractor surface 15 is movable along the longitudinal axis of the heating cavity 5. The extractor surface 15 is movable between three positions, a first position, a second position, and a third position.

The first position is shown in FIG. 4. The first position is a heating position, in which an aerosol-generating article is able to be received in the heating cavity 5 and heated by the heating assembly 8. In the first position, the heating cavity 5 has a depth that is suitable to receive an aerosol-generating article.

The extractor surface 15 is movable in a proximal direction from the first position to a second position. The extractor surface 15 is also movable in a distal direction from the second position to the first position.

The second position is shown in FIG. 5. The second position is an extraction position, in which an aerosol-forming substrate received in the heating cavity 5 is located at or around the open proximal end of the heating cavity 5. In the second position, the extractor surface 15 is arranged at the open proximal end of the heating cavity 5. In the second position, it is easier for a user to reach and remove an aerosol-generating article from the heating cavity 5 than in the first position.

The extractor surface 15 is movable in a distal direction from the first position to a third position. The extractor surface 15 is also movable in a proximal direction from the third position to the first position.

The third position is shown in FIG. 6. The third position is a further heating position, in which two aerosol-generating articles are able to be received in the heating cavity 5 and heated by the heating assembly 8. In the third position, the heating cavity 5 has a depth that is suitable to receive two aerosol-generating articles.

The extractor 14 comprises the extractor surface 15, which is formed from a surface of the heating element 9. The extractor 14 further comprises: a compressible central column 16, a detent 17, and a biasing device 18.

The compressible central column 16 supports the heating assembly 8 at a proximal end of the central column 16. The compressible central column 16 is deformable from the second position of the extractor surface 15 to the first position and to the third position of the extractor surface 15. As such, the entire heating assembly 8 is movable in the heating chamber 5 with the extractor surface 15 between the first position, the second position and the third position. It will be appreciated that in some embodiments only the heating element may be movable with the extractor surface. In particular, where the heating assembly is a resistive heating assembly, only the resistive heating element may be movable with the extractor surface.

The detent 17 extends out from the central column 16 and into a track with a series of notches formed in the housing 6 of the main body 2. The detent 17 moves with the extractor surface 15. The main body 2 is configured to receive the detent 17 of the extractor 14 in the track with the series of notches. The series of notches correspond to when the extractor surface 15 is at the first position, the second position and the third position. When the extractor surface 15 reaches each of the first position, the second position and the third position, the detent 17 may be moved out of the track and into one of the notches to secure the extractor surface 15 in the first position, the second position and the third position respectively. As such, the detent 17, in cooperation with the housing 6 of the main body 2, acts as a stop to locate the extractor surface 15 in each of the first position, the second position and the third position.

The extractor 14 further comprises an arm (not shown) extending out of the housing 6 of the main body 2. The housing 6 of the main body 2 comprises an opening forming a further track that is configured to enable the arm to extend out of the housing 6 and to move in a proximal and distal direction with the extractor surface 15. The arm enables a user to move the extractor surface 15 between the first position, the second position and the third position, and to move the detent 17 into each of the respective notches.

The extractor 14 further comprises a biasing device 18, in the form of a resilient element. In this embodiment, the resilient element is a coil spring circumscribing the central column 16. The coil spring 18 is configured to urge the extractor surface 15 in a proximal direction. In other words, the coil spring 18 is configured to urge the extractor surface 15 from the first position to the second position, and from the third position to the first position.

The biasing device 18 in this embodiment comprises a resilient element. However, it will be appreciated that in some embodiments the biasing means may comprise magnetic biasing means. For example, the biasing means may comprise a permanent magnet arranged beneath the shielding element 11 of the heating assembly, and an electromagnet at the distal end of the central column 16 of the extractor 14. When power is supplied to the electromagnet, the electromagnet may repel the permanent magnet beneath the shielding element 11, and may urge the extractor surface 15 in a proximal direction, from the first position to the second position, and from the third position to the first position.

The main body 2 of the aerosol-generating device 1 further comprises power control circuitry 19 including a controller (not shown), and a power supply 20, in the form of a rechargeable battery. The inductor coil 10 of the heating assembly 8 is electrically connected to the power supply 20 via the power control circuitry 19. The controller of the power control circuitry 19 controls the supply of power from the power supply 20 to the inductor coil 10 of the heating assembly 8.

The power control circuitry 19 supplies an alternating current to the inductor coil 10, which generates an alternating magnetic field. The susceptor element 9 is penetrated by the alternating magnetic field generated by the inductor coil 10, which causes the susceptor element 9 to be heated. An aerosol-forming substrate received in the heating cavity 5 on the extractor surface 15, which is a surface of the susceptor element 9, is heated by the susceptor element 9 when an alternating current is supplied to the inductor coil 10 and the susceptor element 9 is heated by penetration with the alternating magnetic field generated by the inductor coil 10.

The aerosol-generating device 1 further comprises a user interface (not shown) connected to the controller of the power supply circuitry 19 that enables a user to control the generation of aerosol from the aerosol-generating system. In this embodiment, the user interface comprises a user input in the form of a button, which when pressed signals to the controller to supply power to the inductor coil 10 of the heating assembly 8.

FIG. 3 shows a single aerosol-generating article 21 being inserted into the heating cavity 5 of the main body 2. In FIG. 3, the aerosol-generating article 21 is a flat, planar disc of aerosol-forming substrate, in the form of a plug of homogenised cast leaf tobacco wrapped in a porous plug wrap paper. In FIG. 3, the extractor surface 15 is arranged at the first position, such that the heating cavity 5 is sized to fit a single aerosol-generating article 21.

In use, when a user presses the button of the user interface on the main body 2 of the aerosol-generating device 1, the controller supplies power to the inductor coil 10 in the form of an alternating current. When the inductor coil 10 is supplied with an alternating current, the inductor coil 10 generates an alternating magnetic field. The alternating magnetic field penetrates the susceptor element 9, which causes the susceptor element 9 to heat. In turn, the heated susceptor element 9 heats the aerosol-forming substrate in the aerosol-generating article 21 received in the heating cavity 5. The heated aerosol-forming substrate releases volatile compounds.

In use, when a user puffs on the mouthpiece 3 of the aerosol-generating device 1, ambient air is drawn into the aerosol-generating device at the opening at the interface between the mouthpiece 3 and the housing 6 of the main body 2. The ambient air is drawn along the airflow path between the housing 6 of the main body and the mouthpiece 3 to the air inlets 7 at the proximal end of the heating cavity 5. The air inlets 7 direct the air into the heating cavity 5 and onto the aerosol-generating article 21 received in the heating cavity 5. The volatile compounds released from the aerosol-generating article 21 are entrained in the airflow, which is drawn out of the heating cavity 5 into the mouthpiece 3. The volatile compounds cool to form an aerosol, and the aerosol is drawn out of the mouthpiece opening 4 and delivered to the user.

FIGS. 7 and 8 show two aerosol-generating articles, a first aerosol-generating article 21 and a second aerosol-generating article 22, being inserted into the heating cavity 5 of the main body 2 of the aerosol-generating device 1. In FIGS. 7 and 8, the first aerosol-generating article 21 is identical to the first aerosol-generating article 21 shown in FIG. 3, comprising a flat, planar disc of aerosol-forming substrate, in the form of a plug of homogenised cast leaf tobacco wrapped in a porous plug wrap paper. The second aerosol-generating article 22 is a flat, planar disc of aerosol-forming substrate, in the form of a gel comprising nicotine and menthol as a flavourant. The size and shape of the second aerosol-generating article 22 is substantially the same as the size and shape of the first aerosol-generating article 21. In FIGS. 7 and 8, the extractor surface 15 is arranged at the third position, such that the heating cavity 5 is sized to fit two aerosol-generating articles.

In use, when power is supplied to the heating assembly 8 to heat the heating element 9, heat is transferred directly from the heating element 9 to the first aerosol-forming substrate of the first aerosol-generating article 21. The second aerosol-forming substrate of the second aerosol-generating article 22 is heated indirectly via the heated volatile compounds released from the first aerosol-forming substrate and drawn through the second aerosol-forming substrate. Drawing the heated volatile compounds from the first aerosol-forming substrate through the second aerosol-forming substrate heats the second aerosol-forming substrate and releases volatile compounds from the second aerosol-forming substrate.

FIG. 9 shows another embodiment of an aerosol-generating system according to this disclosure. The aerosol-generating system of FIG. 9 comprises an aerosol-generating device 1 and an aerosol-generating article 21.

FIG. 9 shows a portion of the aerosol-generating device 1 that is similar to the aerosol-generating device 1 of FIG. 1, and like reference numerals are used to denote like features. The aerosol-generating device 1 of FIG. 9 comprises a heating cavity 5, a first heating assembly 9, and a second heating assembly 12.

The first heating assembly 9 comprises a first planar heating element, in the form of a flat, circular disc extending in a plane. The second heating assembly 12 comprises a second planar heating element, in the form of a flat, annular disc extending in the plane of the first heating element. The second heating element circumscribes the first heating element.

The first heating element and the second heating element define the distal end of the heating cavity 5.

In this embodiment, the aerosol-generating device does not comprise an extractor. However, it will be appreciated that in other embodiments, the aerosol-generating device may comprise an extractor, and a surface of the first heating element and a surface of the second heating element may form the extractor surface.

It will be appreciated that in other embodiments one or both of the heating assemblies may be inductive heating assemblies.

The aerosol-generating article 21 of FIG. 9 comprises a first aerosol-forming substrate 23 and a second aerosol-forming substrate 24. The first aerosol-forming substrate 23 comprises a flat, planar disc of a first aerosol-forming substrate. The second aerosol-forming substrate comprises a flat, planar ring of a second aerosol-forming substrate, circumscribing the first aerosol-forming substrate 23.

The first aerosol-forming substrate has the same shape and dimensions as the first heating element of the first heating assembly 9. The second aerosol-forming substrate has the same shape and dimensions as the second heating element of the second heating assembly 12. When the aerosol-generating article 21 is received in the heating cavity 5, the first aerosol-forming substrate 23 is aligned with the first heating element, such that the first heating element is arranged to heat the first aerosol-forming substrate. When the aerosol-generating article 21 is received in the heating cavity 5, the second aerosol-forming substrate 24 is aligned with the second heating element, such that the second heating element is arranged to heat the second aerosol-forming substrate.

In this embodiment, the first aerosol-forming substrate comprises a flavouring, such as menthol, and an aerosol-former. The second embodiment comprises a gathered crimped sheet of homogenised tobacco.

The controller (not shown) is configured to supply power to the first heating element of the first heating assembly 9 to heat the first aerosol-forming substrate to a first operating temperature, and is configured to supply power to the second heating element of the second heating assembly 12 to heat the second aerosol-forming substrate to a second operating temperature. The first operating temperature is optimised for the release of volatile compounds from the first aerosol-forming substrate 23. The second operating temperature is optimised for the release of volatile compounds from the second aerosol-forming substrate 24.

The controller is configured to supply power to the first heating element of the first heating assembly 9 independently of the second heating element of the second heating assembly 12. The controller is also configured to supply power to the second heating element of the second heating assembly 12 independently of the first heating element of the first heating assembly 9. As such, the aerosol-generating device of FIG. 9 may heat the first aerosol-forming substrate 23 only, using the first heating element, may heat the second aerosol-forming substrate 24 only, using the second heating element, or may heat a combination of the first aerosol-forming substrate 23 and the second aerosol-forming substrate 24 simultaneously using both the first heating element and the second heating element. A user may control which heating elements are activated by pressing a button on a user interface (not shown).

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±five percent of A.

1.-14. (canceled)

15. An aerosol-generating device, comprising:
a heating cavity configured to receive an aerosol-forming substrate;
a heating assembly arranged in the heating cavity, the heating assembly comprising a planar inductor coil; and
an extractor comprising an extractor surface movable within the heating cavity,
wherein a distal end surface of the heating cavity is defined by the extractor surface,
wherein at least a portion of the extractor surface is formed by a portion of the heating assembly, and
wherein a portion of a surface of the inductor coil forms at least a portion of the extractor surface.

16. The aerosol-generating device according to claim 15,
wherein the heating cavity has a longitudinal axis, and
wherein the extractor surface is movable along the longitudinal axis of the heating cavity.

17. The aerosol-generating device according to claim 15,
wherein the heating cavity has a proximal end and a distal end opposite the proximal end,
wherein the proximal end is substantially open,
wherein the extractor surface is movable in a proximal direction towards the proximal end of the heating cavity from a first position to a second position, and
wherein the extractor surface is movable in a distal direction towards the distal end of the heating cavity from the second position to the first position.

18. The aerosol-generating device according to claim 17,
wherein the first position is a heating position, in which an aerosol-forming substrate is able to be received in the heating cavity and heated by the heating assembly, and
wherein the second position is an extraction position, in which an aerosol-forming substrate received in the heating cavity is located at, around or outside the open proximal end of the heating cavity.

19. The aerosol-generating device according to claim 18, wherein in the second position the extractor surface is arranged at the open proximal end of the heating cavity or outside of the heating cavity.

20. The aerosol-generating device according to claim 18,
wherein the extractor surface is movable in a distal direction towards the distal end of the heating cavity from the first position to a third position, and
wherein the extractor surface is movable in a proximal direction towards the proximal end of the heating cavity from the third position to the first position.

21. The aerosol-generating device according to claim 20, wherein the third position is an additional heating position, in which a greater volume of aerosol-forming substrate is able to be received in the heating cavity and heated by the heating assembly compared to when the extractor surface is in the first position.

22. The aerosol-generating device according to claim 15,
wherein the heating assembly further comprises a heating element, and
wherein a surface of the heating element forms at least a portion of the extractor surface.

23. The aerosol-generating device according to claim 15, wherein the heating assembly further comprises a heating element in a form of a susceptor element.

24. The aerosol-generating device according to claim 15, wherein the inductor coil is movable with the extractor surface of the extractor.

25. The aerosol-generating device according to claim 15,
wherein the heating assembly is a first heating assembly comprising a first planar heating element extending in a plane, and
wherein the aerosol-generating device further comprises a second heating assembly comprising a second planar heating element extending in the plane of the first heating element, and circumscribing the first heating element.

26. The aerosol-generating device according to claim 25, wherein the first heating element is substantially circular and the second heating element forms a ring circumscribing the first heating element.

27. The aerosol-generating device according to claim 15, further comprising a biasing device configured to urge the extractor surface towards an open proximal end of the heating cavity.

28. An aerosol-generating system, comprising the aerosol-generating device according to claim 15; and an aerosol-forming substrate.

29. The aerosol-generating system according to claim 28,
further comprising an aerosol-generating article comprising the aerosol-forming substrate,
wherein the aerosol-generating article is a circular, planar disc.
